(19) United States
(12) Patent Application Publication
(10) Pub. No.: US 2003/0144774 A1
(43) Pub. Date: Jul. 31, 2003

(54) Kit and method for converting conventional lawnmower to a robotic lawnmower

(76) Inventors: Ronald L. Trissel, Lakeland, FL (US); Vernon Stonerock, Altamonte Springs, FL (US); Joe L. Longoria, Sanford, FL (US)

Correspondence Address: Elsie C. Turner, 201 Park Place Suite 204, Altamonte Springs, FL, 32701, US

(21) Appl. No.: 10/057,881

(22) Filed: Jan. 29, 2002

(51) Int. Cl. G06F 19/00

(52) U.S. Cl. 701/23; 700/245

(57) ABSTRACT

A kit and method converts a conventional gasoline-fueled walk-behind lawnmower to a robotic lawnmower. The existing transmission is replaced with a motorized front wheel drive transmission which can engage and disengage the front wheels independently of each other, thereby steering the vehicle. An electronic control system controls the starter switch, the engine throttle, and the transmission and steering of the vehicle. A navigational system is included which continuously communicates position and direction of travel to the electronic control system. A variety of sensors detect operating conditions, hazards and obstacles in the vehicle's path which data are also communicated to the control system. A microprocessor in the control system stores these data in a programmable memory as a map of the area to be mowed. During a learning mode, the user utilizes a control panel in operative communication with the electronic control system to control and guide the vehicle along the desired path and create the map. During operating mode, the microprocessor accesses the map and commands the electronic control system to maneuver the vehicle in accordance with the map. The control panel displays the operating status of the vehicle at all times when the vehicle is turned on.

### FIELD OF THE INVENTION

This invention relates generally to autonomous “robotic” lawnmowers capable of cutting a predetermined grass area without human intervention, and more particularly a kit and method for converting a conventional walk-behind gasoline-powered mower to a robotic mower.

### BACKGROUND OF THE INVENTION

A number of autonomous vehicle inventions are known in the prior art. U.S. Pat. No. 4,600,999 to Ito et al. teaches an autonomous vehicle having a device for defining the outer periphery of a work site and automatically deducing a running course covering the interior of the work site. U.S. Pat. No. 5,925,080 to Shimbara et al. is for an automatic guided vehicle which travels a path established by a path guide laid on the surface to be traveled. U.S. Pat. No. 6,112,143 to Allen et al. is for an automatically controlled vehicle which involves activating a learning mode, positioning the mower at a plurality of locations on a perimeter and recording positioning data at each location. The position data is stored in a data processor which generates a display of th perimeter. U.S. Pat. No. 4,700,301 to Dyke discloses a method for automatically steering a motor vehicle on a programmed course by continuously measuring angles between reference points, suing a microprocessor to calculate the vehicle position and direction of motion.

Pong et al., U.S. Pat. No. 4,962,453, discloses a vehicle using information derived from contact between bumpers and objects in the environment to sense the geometry of the environment, the data then being used to generate an algorithm to cover the area. U.S. Pat. No. 5,204,814 to Noonan et al., uses an electronically stored path and terrain information as a primary navigation system, and metallic guide path for a secondary navigation system. It incorporates an ultra sonic obstacle detection system for stopping the vehicle if unexpected obstacles are encountered. Diekhans, U.S. Pat. No. 6,101,795, is for an automatic steering mechanism for a self-propelled machine which scans a crop edge, such as the border between mowed and unmowed crops, to produce signals for the steering mechanism. Nelson, U.S. Pat. No. 5,974,347, utilizes a rotating directional loop antenna to determine position within a cutting area by measuring the angle between transmitters placed in a known configuration outside of the cutting area, and then stores the path information. The Angott et al. U.S. Pat. No. 6,009,358, is for a mower controlled y a central processing unit to follow a predetermined route, using first and second locating transmitters to determine the route. No. 5,163,273 to Wojtkowski et al., is for a mower that follows a buried wire.

These patents illustrate that the overall concept of an automatically controlled lawn mower which has a learning mode to determine cutting area and which stores the path information in a database is well-known in the prior art. None of these patents, however, teaches the conversion of a mass-marketed gasoline-engine walk-behind mower to robotic mower. In fact the robotic mowers that are currently available to the consuming public are electrically powered by batteries, are very time-consuming to set up and train, slow to perform the mowing task, need recharging often, and need frequent battery replacement. Accordingly an object of this invention is to provide a means and method whereby the average homeowner, or manufacture of conventional mowers, can convert his existing walk-behind gasoline-fueled lawnmower to a robotic mower. It is another object of this invention to provide a gasoline-fueled robotic mower which is consequently faster to “train” and faster in accomplishing the mowing task than the electric models now available. Yet another object of the invention is to utilize a dual navigational system of global positioning and dead reckoning to ensure constant monitoring of the mower's position, thus a high degree of accuracy in accomplishing the mowing task. Still another object of this invention is to provide an autonomous vehicle with a highly maneuverable drive system.

### SUMMARY OF THE INVENTION

The foregoing objects of the invention are achieved by providing a kit and method for converting a conventional gasoline-fueled walk-behind lawnmower to a robotic lawnmower. The existing transmission is replaced with a motorized front wheel drive transmission which can engage and disengage the front wheels independently of each other, thereby steering the vehicle. An electronic control system is provided which controls the starter switch, the engine throttle, and the transmission and steering of the vehicle. A navigational system is included which continuously communicates position and direction of travel to the electronic control system. A variety of sensors detect operating conditions, hazards and obstacles in the vehicle's path which data are also communicated to the control system. A microprocessor in the control system stores these data in a programmable memory as a map of the area to be mowed. During a learning mode, the user utilizes a control panel in operative communication with the electronic control system to control and guide the vehicle along the desired path and create the map. During operating mode, the microprocessor accesses the map and commands the electronic control system to maneuver the vehicle in accordance with the map. The control panel displays the operating status of the vehicle at all times when the vehicle is turned on.

### BRIEF DESCRIPTION OF THE DRAWINGS

FIG. 1. is a side elevational view of a conventional, gasoline-powered, walk-behind lawnmower without the kit of this invention.

FIG. 2 is top plan view of the mower of FIG. 1

FIG. 3 is a side elevational view of the mower of FIGS. 1 and 2 converted to a robotic mower by the kit of this invention.

FIG. 4 is a top plan view of the robotic mower of FIG. 3

FIG. 5 is a perspective view of the mower of FIGS. 3 and 4.

FIG. 6 is a system data-flow diagram of the invention

FIG. 7 is a top plan view of the detachable operator panel of this invention

FIG. 8 is a side elevational view of the panel of FIG. 7

FIG. 9 is a perspective view of the drive transmission of this invention

FIG. 10 is a top plan view of the drive transmission of FIG. 9.

FIG. 11 is a front elevational view of the drive transmission of FIGS. 9 and 10.

FIG. 12 is a block diagram of the mechanical system of this invention.

FIG. 13 is a block diagram of the power distribution system of this invention.

FIG. 14 is a block diagram of the data connections system of this invention.

### DETAILED DESCRIPTION OF THE PREFERRED EMBODIMENTS

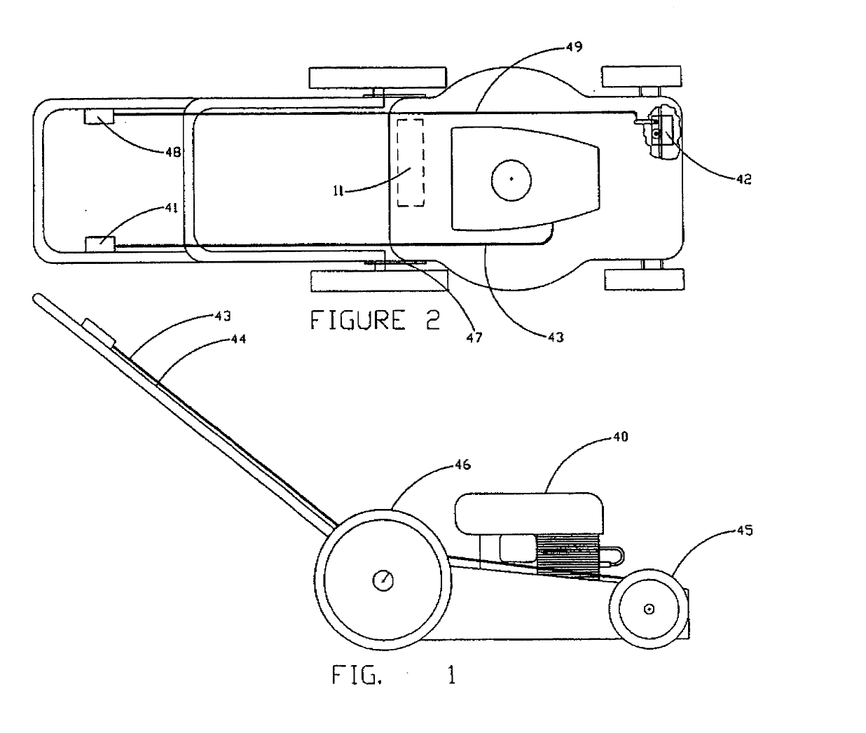

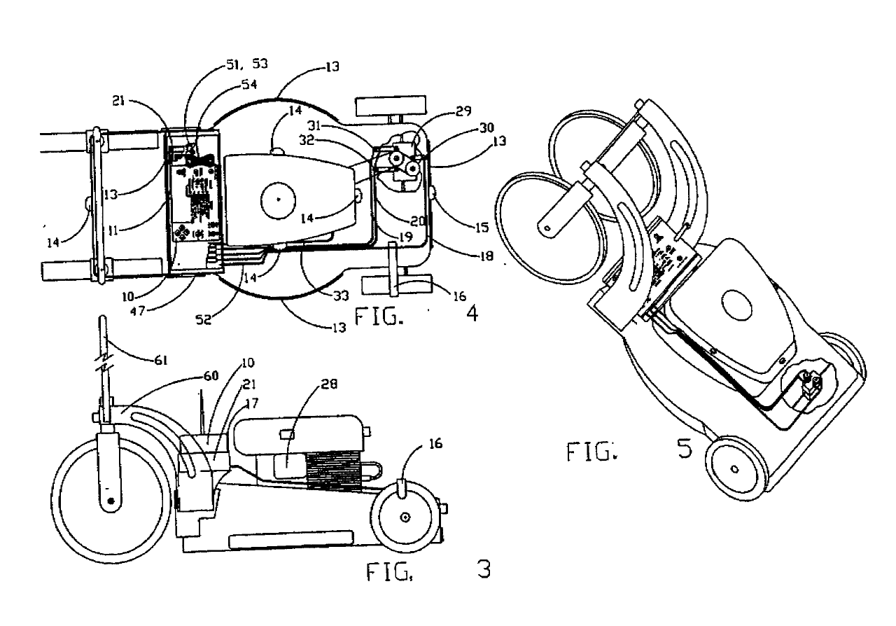

A typical gasoline-powered walk-behind lawnmower, suitable for conversion to a robotic mower using the kit of this invention, is represented in FIGS. 1 and 2. One such mower available on the market is the Sears Model 37720. It has a 6¾ horsepower gasoline engine 40, an electric starter 41, 12-volt battery 11, and front wheel drive 42. To install the elements of the kit of this invention, the rear handle 44 with throttle control cable 43 and starter switch 41, the handle's mounting brackets 47, front wheels 45, transmission 42, and rear wheels 46 are removed and saved. The engage lever 48 and transmission control cable 49 are removed and replaced with various electrical, mechanical, and electronic elements of this invention, to be described later.

FIGS. 3, 4 and 5 show wheels 45 and 46 re-installed with the kit's mechanical components, which provide the means to attach an electronic control system board 21, a detachable operator panel 10, and the mounting of a replacement transmission 29. The transmission components comprise two major assemblies. The first assembly is a heavy-duty aluminum mounting bracket 60 located between the lawnmower handle mounting brackets 47. It is installed on the lawnmower by using existing holes used for the old rear wheel brackets, in the deck plate. Drilling holes in the lawnmower will not be required for mounting this assembly. Bracket 60 extends the rear wheels 46 back about 10 inches and allows each wheel 46 to rotate through 360 degrees. Access to the battery 11, gas, oil, and blade for maintenance is still available. The electronic control system board 21 is attached directly to the mounting bracket 47 cross member shelf. The detachable operator panel 10 is clip-mounted directly on top of the electronic control system board 21. A removable tow handle 61 can be mounted on the rear of the mounting bracket 47 cross member shelf. The removable tow handle 61 is used to transport the lawnmower from its storage area to the starting position in the landscape to be cut. This assembly is pre-assembled with the electronic control system board 21, the detachable operator panel 10, removable tow handle 61, and four cables to cable control motors 18, 19, 20 and 33 involving gear selection, steering, and throttle control, which will be more fully described later. To install the mechanical components, first this pre-assembled first assembly is bolted on the lawnmower. Next, cables to the four control motors 18, 19, 20 and 33 and electrical power cables 51, from the battery to the electronic control system board 21, and 52, from the control board 21 to the electric starter 28, are connected. Lastly, the rear wheels 46 are reinstalled.

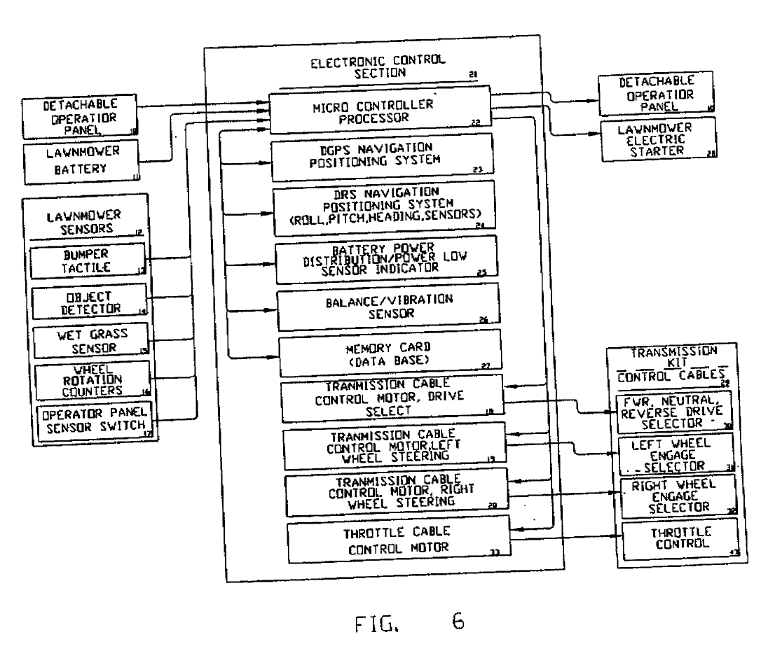

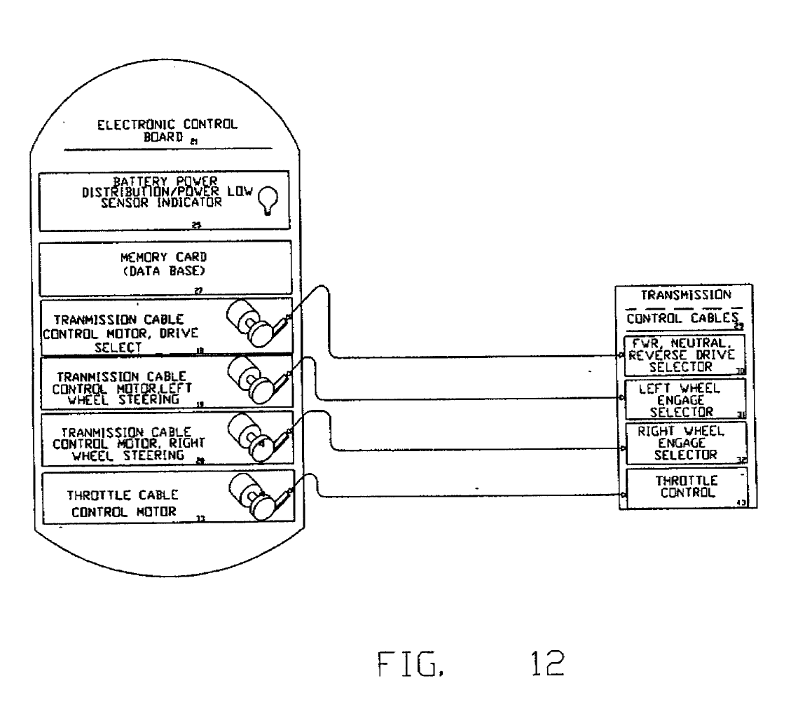

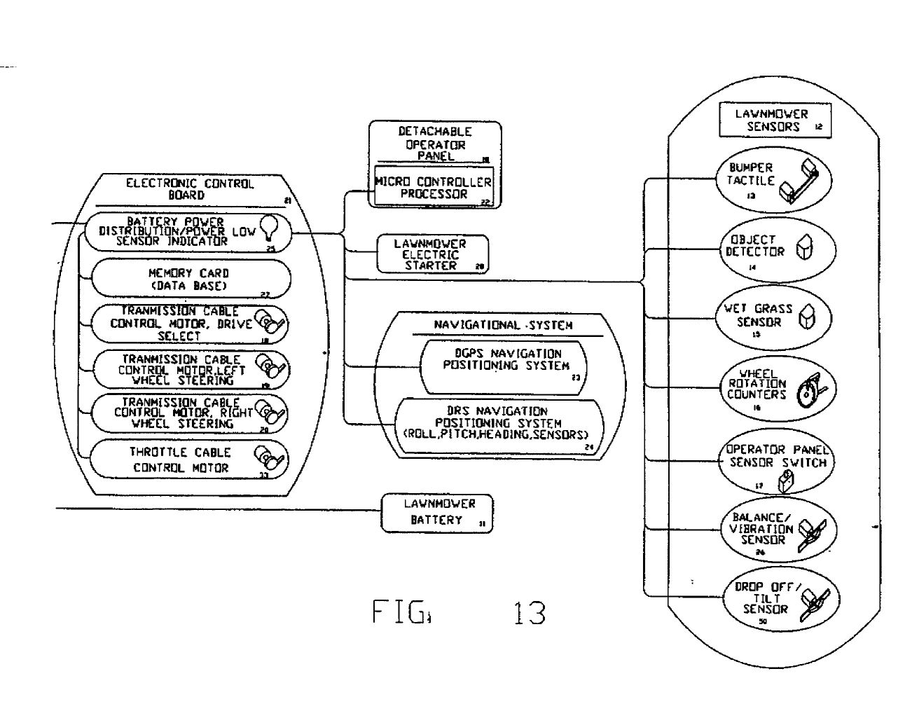

The second major assembly of mechanical components provides the steering action of the lawnmower. This is accomplished with a replacement transmission 29, shown in FIGS. 4, 9, 10 11 and 12, which selects forward, neutral or reverse gears, and engages or disengages each wheel separately or together. Control motor 18 moves gear selector 30 among the three gears. Control motor 19 moves the engage/disengage lever 31 for the left front wheel 45, and control motor 20 moves the engage/disengage lever 32 for the right front wheel 45. The method of steering involving engaging either or both front wheels to the drive shaft is virtually the same as that of the lawnmower prior to conversion. Cable control motor 33 operates the engine throttle 43.

Sensory features shown in FIG. 4 include four bumper tactile sensors 13 and three object sensors 14 disposed on each side and at the front and rear of the mower. Bumper tactile sensors 13 sensors are micro switches based with ‘probes’ that extend out beyond the deck housing of the lawnmower. These positioned about four inches off the ground. Hitting a low-level object activates the bumper bumble sensors 13. The object sensors 14 are optic type sensors mounted on the lawnmower twelve inches off the ground, with a detection range of four feet. These sensors 14 are activated when an undefined object is detected in its field of view. A wet grass sensor 15 is mounted in the front section of the lawnmower housing deck, extending down to blade level. This sensor 15 is activated during wet grass conditions.

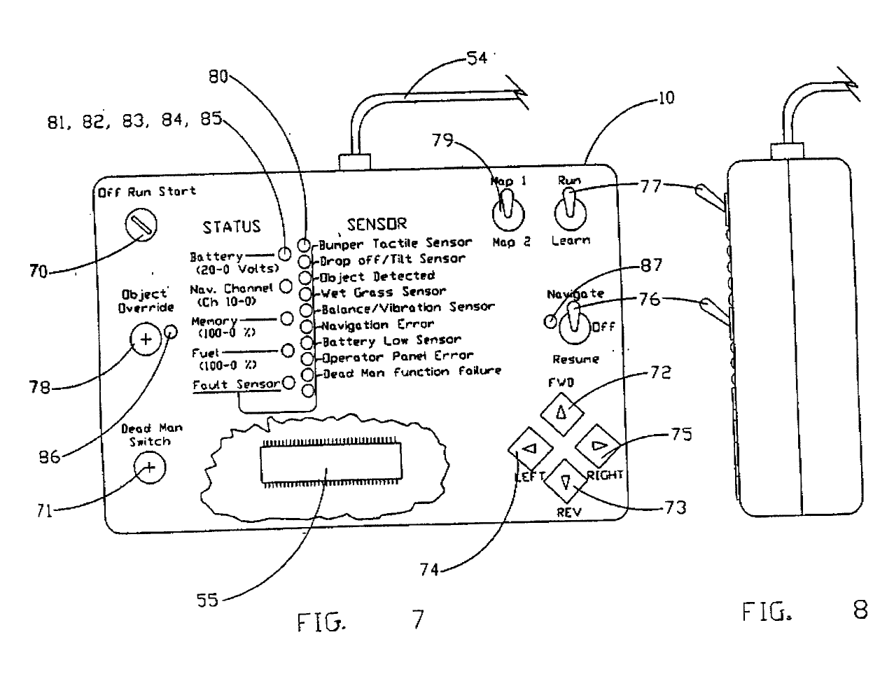

A major sensory feature of the invention is the navigational system which determines the location of the robotic mower. In the preferred embodiment, the invention has two navigation systems, to provide an accurate position of the self-propelled walk behind lawnmower while in operation. The first one is a differential global positioning system (DGPS) 23, and the second one is a dead reckoning system (DRS) 24. Both navigation systems 23 and 24 are located in the electronic control system board 21, as shown in FIG. 6, the system data flow block diagram. When a signal from DGPS 23 signal is not available, DRS 24 is used until the DGPS 23 signal becomes available. At least one of the navigation positioning systems, 23 or 24 must be available at all times. DGPS 23 could be a commercial chip set type or GPS module for mobile products such as the M-Loc™ MPM™ module manufactured by Trimble Navigation LtdA minimum of four tracking satellites are required for the desired DGPS 23 position accuracy, which should be measured in inches. DRS 24 is a system using a compass to determine heading and a real time clock chip in combination with wheel-revolution counters 16 to measure distance traveled by the lawnmower. It should have a position accuracy that is measured in inches. Preferably the compass is a commercial model which contains ‘roll’ and ‘pitch’ functions that serve as a tilt/dropoff sensor 50, indicated in FIG. 5. This sensor 50 is activated when either ‘roll’ or ‘pitch’ values exceed five degrees. The dual navigation position systems 23 and 24 provide lawnmower position, roll, pitch, heading, GPS coordinates data, and real time in both the ‘run’ and ‘learn’ modes.

Other sensors indicated in FIG. 6 include a balance/vibration sensor 26 mounted inside the electronic control system board 21. This sensor 26 is activated if the lawnmower has excessive vertical and or horizontal movement. Examples would be a broken blade or continuous ramming of an object if a bumper tactile sensor 13 failed. A battery low voltage sensor 25 prevents operating the lawnmower when the battery 11 voltage is too low to reliably operate the cable control motors 18, 19, 20, 33 and sensors 13-17, 25, and 26.

The electronic control system 21 receives power from the lawnmower battery 11 and information as to its location from navigation systems 23 and/or 24. The electronic control system board 21 has a micro controller processor 22 which receives data from the navigational systems 23 and 24, and sensors 13-17, 25, and 26. These data are acquired in both ‘learn’ and ‘run’ modes. The processor 22 receives instructions from the detachable operator panel 10 during its ‘learn’ mode and stores them in the programmable memory card 27 as a map of the landscape area to be mowed. Memory card 27 could have as an option enough storage area to store two maps for two separate landscapes, as well as the data necessary to handle two full tanks of gasoline. During the ‘run’ mode, wherein the lawnmower is robotic, the mower receives instructions from processor 22 according to the map stored in the memory card (database) 27. Processor 22 controls the movements of the mower in its ‘run’ mode by means of transmission cable control motors 18, 19, and 20, which connect the electronic control system 21 to the replacement transmission 29 of this invention. Cable control motor 33 connects the processor 22 to the engine throttle 43 This allows the controller processor 22 to shut off the fuel to the gas engine 40, thus stopping the lawnmower.

Processor 22 informs status displays 80-85, located on the detachable operator panel 10 represented in FIG. 7, whether or not sensors and systems are operating properly.

A more detailed description of the operator panel 10 follows later herein. Processor 22 also controls the mower electric starter 28.

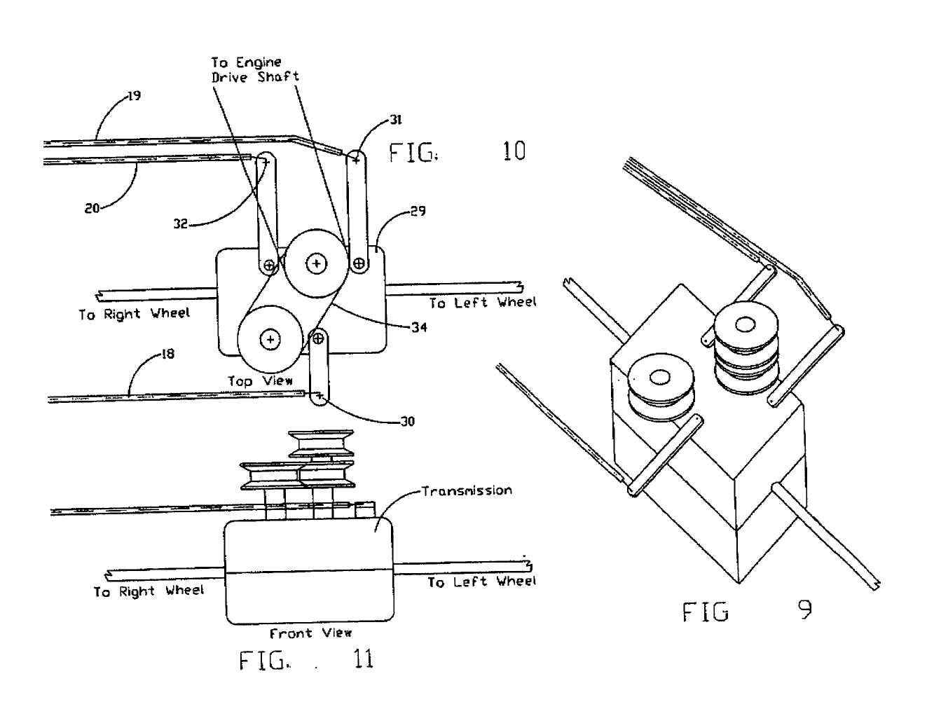

FIGS. 7 and 8 depict the detachable operator panel 10. Panel 10 displays the current status of the lawnmower operating conditions, and manually controls the lawnmower during the mapping of a landscape area. The detachable operator panel 10 receives its power from, and communicates with, the electronic control system board 21 via an electrical cable 54. Panel 10 allows the user to walk beside the lawnmower, operating it without touching it, during the mapping of a landscape area. The detachable operator panel 10 and connecting cable 54 are attached to the electronic control board 21 during storage and when cutting the landscape area. The panel 10 should be watertight in all areas.

The operating status is always displayed whether in the landscape mapping or grass cutting mode. As a minimum, the status is displayed using seven individual light emitting diodes (LEDs) 81, 82, 83, 84, 85, 86, and 87 and ten LEDs arranged as a ten-segment bargraph 80. The bargraph 80 is used to show the battery voltage level, from 20 to 0 volts DC, the number of navigation channels currently being used, from 10 plus to 0, free memory remaining in the memory card 27, from 100 to 0 per cent, estimated time remaining based on fuel remaining, from 100 to 0 minutes, any faulted on board sensors 12, from 10 to 0.

Each of the bargraph 80 displays is shown for one second in continuous rotation. The five individual status LEDs next to the bargraph 80 LEDs to indicate when the battery voltage 81, navigation channels 82, free memory 83, fuel remaining 84, and faulted sensors 85 status is being shown. For unscheduled lawnmower stops, the bargraph 80 will freeze and hold the faulted sensor display 85. The sixth individual LED 86 displays the status of optical object sensors 14. It will come on when any of the four object sensors 14 are activated The seventh individual LED is the navigational marker 87. It will flash each time when recording location data point from the dual navigation positioning system 23, 24 or when using a location data point from the database. It will remain on when not recording or reading the location data from the database.

The detachable operator panel 10 has ten switches used for manual control of the lawnmower during the mapping of a landscape area when in the ‘Learn’ mode. Switch 70 is a keylock start switch. Turning the switch all the way over and releasing it to the run position will electrically start the lawnmower. The keys for the start switch, along with the memory card 27 make up the security system for the lawnmower. Both items are required to operate the lawnmower. Switch 71 is a push button. Pushing the switch down engages a ‘dead man’ feature, which allows the key start switch to work. Holding the switch allows the lawnmower engine 40 to run. Releasing this switch will stop the lawnmower engine 40 as per the ‘dead man’ feature. Switch 72 is a push button switch for selecting the forward drive direction. Releasing this switch will place the drive direction in neutral. Switch 73 is a push button switch for selecting the reverse drive direction. Releasing this switch will place the drive direction in neutral. Switch 74 is a push button switch for selecting the left turning drive direction. Releasing this switch will place the steering to the center direction. Switch 75 is a push button switch for selecting the right turning drive direction. Releasing this switch will place the steering to the center direction. To make a left forward turn, switch 72 (forward) must be pressed simultanously with switch 74 (left turn). Switch 74 is released to stop turning left. Switch 76 is a centered three-position toggle switch. One position starts recording the navigation locations, one position is off for no recording, and in the third position, recording is resumed if the current lawnmower navigation position has been previously recorded. The resume feature will also erase all navigation positions in the memory card (database) 27 later than the current navigation position. The resume feature allows the user to ‘back-up’ while mapping a target area, instead of starting over from the beginning. Switch 77 is a two-position toggle switch for placing the lawnmower in the ‘learn’ or ‘run’ modes of operation. When in the ‘learn’ mode, the detachable operator panel 10 can be detached from the electronic control system board 21. When in the ‘run’ mode, the detachable operator panel 10 must be attached to the system board 21. With its on board sensors 12 it becomes a ‘dead man’ feature. Switch 78 is a push button type switch, which is only active during the ‘learn’ mode, and when the object sensor LED 86 is on. If a stationary valid object (tree, rock, fence, etc.) is detected during the ‘learn’ mode, the user can press and hold the object override switch 78 until the object detect LED 86 goes out. This information will be recorded in the memory card (database) 27, which will allow the lawnmower to continue cutting the grass in this area during the ‘run’ mode. Switch 79 is a two-position toggle switch for selecting the mapping or cutting of two separate landscapes, labeled as ‘Map 1’ and ‘Map 2’.

All the detachable operator panel 10 components such as switches and displays are connected to a micro controller processor chip 55 located inside the detachable operator panel 10. This micro controller processor chip 55 communicates with the micro controller processor 22 located in the electronic system board 21 via panel 10. System board 21 and operator panel 10 must communicate once every second, otherwise the lawnmower engine 40 is shut down.

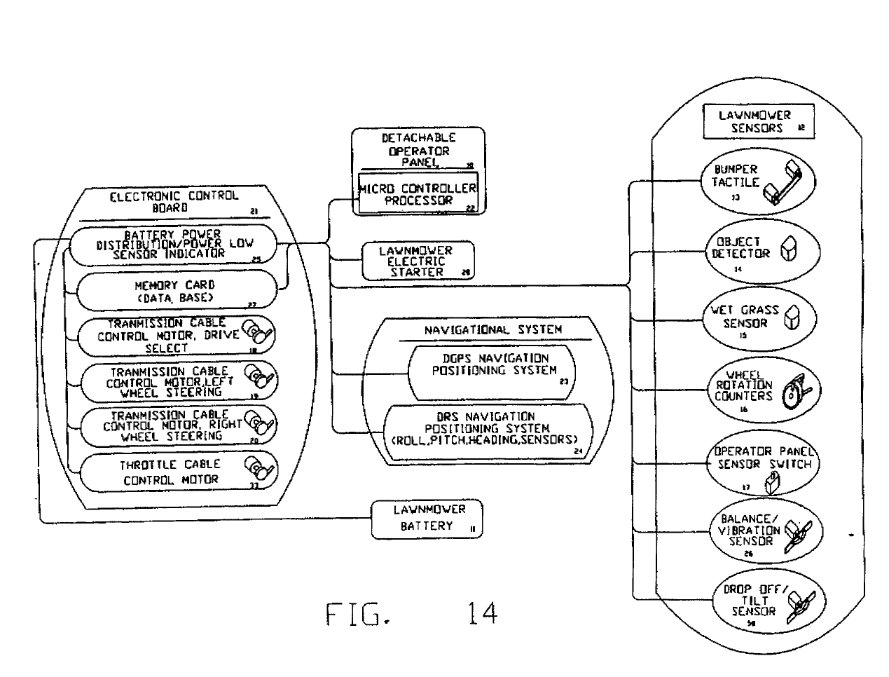

As shown in FIG. 13, all sensors are connected to the micro controller processor 22 located in the electronic control member 21. Activating any sensor will cause the micro controller processor 22 to update the LED ten-segment bargraph 80, turn on the faulted display LED 81, 82, 83, 84, or 85, and shut off the gas engine 40. Any activated sensor acts as a ‘dead man’ feature when the lawnmower is in the ‘run’ mode. The memory card 27 and the dual navigation positioning system 23 and 24, not being in agreement, within tracking limits of the lawnmower current position, cause Navigation Error, displayed by the bar graph 80. The operator panel 17 sensor switch prevents operating the lawnmower in the ‘run’ mode with the detachable operator panel 10 detached. If the detachable operator panel 10 is detached during the ‘learn’ mode, it will cause the Operator Panel Error. The Dead Man function error is the failure of not holding the dead man switch 71, on the detachable operator panel 10, in the down position during the ‘Learn’ mode. Prior to using the lawnmower for the first time, the user must manually test the sensors 13, 14, 15, 26, and 50, as instructed in the user operator manual which is included in the kit. The processor 22 will record the results in the memory card 27. The lawnmower will start only when the memory card 27 contains data that the sensors were satisfactorily tested.

We claim:

1. A kit for converting a conventional, walk-behind lawnmower to a robotic mower able to cut a predetermined grass area without human intervention, said conventional lawnmower having a gasoline engine with a throttle, an electrical starter and storage battery, left and right front and rear wheels, and a conventional front-wheel drive transmission and drive shaft, said kit comprising:
steering and replacement transmission means for shifting between forward, neutral, and reverse gears, and for reversibly engaging each front wheel independently to and from the drive shaft;
replacement mounting brackets for the rear wheels allowing them to rotate through 360 degrees;
electrical motors powering said steering and transmission means, gear selection, and the engine throttle;
a navigational system for detecting position and direction of travel of the mower in a landscape and for electronically communicating position and direction of travel;
a sensory system for detecting operating hazards and obstacles in the path of the mower;
a kill switch member to shut off fuel to the engine upon detection of a hazard or obstacle;
an electronic control system in operative communication with the storage battery, the navigational system, the steering and transmission means, the electrical motors, the electrical starter, the sensory system, and the kill switch member, said electronic control system having a central processing unit (CPU) with a programmable memory for acquisition and storage of information derived through said control system to create a map of a selected cutting path to be traveled by the robotic mower, said information obtained during a learning mode, said CPU having command means to start the robotic mower, to control its movements according to said cutting path during a cutting mode, and to activate the kill switch upon detection of a hazard; and
a detachable operator control panel in operative communication with said electronic control system, said panel for displaying current status of the robotic operating conditions and for manually controlling movements of the robotic mower during its learning mode.

2. The kit according to claim 1, wherein the navigational system comprises a plurality of position finding systems.

3. The kit according to claim 2, wherein the sensory system comprises:
first sensory means for tactile detection of impeding objects in the path of the mower;
second sensory means for optical detection of undefined objects in the path of the mower;
third sensory means for detecting wet grass;
fourth sensory means for detecting roll and pitch of the mower;
fifth sensory means for detecting excessive vertical or horizontal motions and vibrations of the mower;
sixth sensory means for detecting low voltage in the electrical storage battery source;
seventh sensory means for detecting navigational error; and
eighth sensory means for detecting operator panel error.

4. The kit according to claim 3 wherein one of the position finding systems is a dead reckoning system comprising a digital compass, a real time clock chip, and means for detection of distance traveled by the mower.

5. The kit according to claim 4 wherein the means for detection of distance traveled comprises sensors for counting revolutions of a rear wheel of the mower.

6. The kit according to claim 5 wherein the digital compass contains roll and pitch functions, thereby serving as the fourth sensory means.

7. The kit according to claim 6 wherein another of the position finding systems is a differential global positioning system obtaining data from a plurality of tracking satellites, whereby the robotic mower achieves accuracy of its position to inches.

8. The kit according to claim 7 wherein the programmable memory has sufficient storage area to store maps of at least two separate landscape areas and to support using two full tanks of gas.

9. A kit for converting a conventional, walk-behind lawnmower to a robotic mower able to cut a predetermined grass area without human intervention, said conventional lawnmower having a gasoline engine with a throttle, an electrical starter and storage battery, left and right front and rear wheels, and a conventional front-wheel drive transmission and drive shaft, said kit comprising:
steering and replacement transmission means for shifting between forward, neutral, and reverse gears, and for reversibly engaging each front wheel independently to and from the drive shaft;
replacement mounting brackets for the rear wheels allowing them to rotate through 360 degrees;
electrical motors powering said steering and transmission means, gear selection, and the engine throttle;
at least two navigational systems for detecting position and direction of travel of the mower in a landscape and electonically communicating position and direction of travel, one of said navigational systems comprising a dead reckoning system comprising comprising a digital compass, a real time clock chip, and means for detection of distance traveled by the mower, and another of said navigational systems comprising a a differential global positioning system obtaining data from a plurality of tracking satellites, whereby the robotic mower achieves accuracy of its position to inches.
a sensory system for detecting hazards, comprising first sensory means for tactile detection of impeding objects in the path of the mower, second sensory means for optical detection of undefined objects in the path of the mower, third sensory means for detecting wet grass, fourth sensory means for detecting roll and pitch of the mower, fifth sensory means for detecting excessive vertical or horizontal motions and vibrations of the mower, sixth sensory means for detecting low voltage in the electrical storage battery source, seventh sensory means for detecting navigational error, and eighth sensory means for detecting operator panel error;
a kill switch member to shut off fuel to the engine;
electronic control system in operative communication with the storage battery, the navigational system, the steering and transmission means, the electrical motors, the electrical starter, the sensory system, and the kill switch member, said electronic control system having a central processing unit (CPU) with a programmable memory for acquisition and storage of information derived through said control system to create a map of a selected cutting path to be traveled by the robotic mower, said information obtained during a learning mode, said CPU having command means to start the robotic mower, to control its movements according to said cutting path during a cutting mode, and to activate the kill switch upon detection of a hazard; and
a detachable operator control panel in operative communication with said electronic control system, said panel for displaying current status of the robotic operating conditions and for manually controlling movements of the robotic mower during its learning mode.

10. The kit according to claim 9 wherein the means for detection of distance traveled comprises sensors for counting revolutions of a rear wheel of the mower.

11. The kit according to claim 5 wherein the digital compass contains roll and pitch functions, thereby serving as the fourth sensory means.

12. The kit according to claim 11 wherein the programmable memory has sufficient storage area to store maps of at least two separate landscape areas and to support using two full tanks of gas.

13. A method for converting a walk-behind lawnmower powered by a gasoline engine to a robotic lawnmower, said walk-behind mower having a chassis, a rear handle with throttle control cable, electric starter switch, storage battery, right and left front and rear wheels, a front-wheel drive transmission with engage lever, and rear-wheel mounting brackets, said method comprising the steps of:
removing the pre-existing rear handle, throttle control cable, transmission engage lever and transmission control cable, and front and rear wheels; providing a new motorized front-wheel drive transmission system comprised of a motor-powered gear shift and independent motor-powered right and left front wheel engage/disengage levers;
replacing the front wheels and connecting them to the motorized front-wheel drive transmission;
providing a heavy-duty mounting bracket between the pre-existing lawnmower handle mounting brackets, and replacement of said rear wheels thereon, whereby said rear wheels are spaced from the lawnmower chassis so that they are capable of rotating through 360 degrees;
providing sensory means for detection of operating obstacles and hazards in the path to be traveled by the lawnmower;
providing a navigational system capable of generating position and distance traveled data;
providing an electronic control system on said heavy duty mounting bracket, said electronic control system in operative communication with said starter switch, said motorized transmission, said engine throttle, said sensory means, and said navigational system, comprising:
programmable memory means for storing sensory and position data as a map of the area to be mowed;
microprocessor means for receiving sensory and position data, for storing said data in said memory means, for starting and stopping said engine, and for controlling movements of said mower in accordance with the map stored in the memory means; and
a detachable operator control panel in operative communication with said electronic control system, said panel for displaying current status of the robotic operating conditions and for manually controlling movements of the robotic mower during a mapping mode.

14. The method according to claim 13 further comprising the step of providing a kill switch in operative communication with said electronic control system, for stopping said mower when said system receives sensory data indicating a hazard.

15. The method according to claim 14 wherein said sensory means comprises:
first sensory means for tactile detection of impeding objects in the path of the mower;
second sensory means for optical detection of undefined objects in the path of the mower;
third sensory means for detecting wet grass;
fourth sensory means for detecting roll and pitch of the mower;
fifth sensory means for detecting excessive vertical or horizontal motions and vibrations of the mower;
sixth sensory means for detecting low voltage in the electrical storage battery source;
seventh sensory means for detecting navigational error; and
eighth sensory means for detecting operator panel error.

16. The method according to claim 14 wherein said navigational system comprises a plurality of position finding systems.

17. The method according to claim 16 wherein one of said position finding systems comprises a dead reckoning system having a digital compass, a real time clock chip, and means for detection of distance traveled by the mower.

18. The method according to claim 17 wherein another of said position finding systems is a differential global positioning system receiving position data from a plurality of tracking satellites, whereby the robotic mower achieves accuracy of its position to inches.
